(19) United States
(12) Patent Application Publication
(10) Pub. No.: US 2012/0107185 A1
(43) Pub. Date: May 3, 2012

(54) Interface Between Components of a Chemistry Module Based on a Set of Movable Containers

(75) Inventor: Artem Lebedev, Culver City, CA (US)

(73) Assignee: SIEMENS MEDICAL SOLUTIONS USA, INC., Malvern, PA (US)

(21) Appl. No.: 13/283,668

(22) Filed: Oct. 28, 2011

Related U.S. Application Data
(60) Provisional application No. 61/407,487, filed on Oct. 28, 2010.

(51) Int. Cl. B01J 19/28; F17D 3/00; B01D 15/08

(52) U.S. Cl. 422/159; 210/198.2; 137/561 R

(57) ABSTRACT

An apparatus for carrying out a chemical synthesis and related systems and methods are disclosed. The apparatus may comprise at least one rotatable drum comprising at least one slot having at least one chemical reagent or a cartridge, and at least one system block configured to be in communication with the at least one chemical reagent. The system block may comprise at least one means for extracting reagent from the slot. The apparatus may comprise a plurality of slots and a plurality of system blocks, wherein each system block may be in communication with at least one slot of reagent or cartridge.

### CROSS-REFERENCE TO RELATED APPLICATIONS

The present application claims priority to U.S. Ser. No. 61/407,487, filed on Oct. 28, 2010; the entire contents of which are incorporated by reference herein.

### FIELD OF THE INVENTION

The present embodiments relate to apparatuses for transferring liquids, gases, solids, semi-solids, etc. Such transfer may be a part of chemical synthesis modules or part of a chemical process. Such chemicals may be synthesized for use in imaging technologies such as positron emission tomography (PET) and/or Single-photon emission computed tomography (SPECT). Such chemicals may also be used as for therapeutic purposes, for example in radiotherapy of cancer.

### BACKGROUND

In known chemical synthesis systems, materials such as liquids and gases are transferred from one place to another via tubing, which is usually plastic. With these systems, in many cases, material is lost during the transfer. Also, the plumbing may clog, the lines may pinch or leak, etc. Further, some of these systems are not easily adaptable to various tasks. In addition, the fixed plumbing schematic of the tubing-based instruments implies that all functions of the machine must be defined at the design stage. But operations often require changes in the existing schematic. These changes trigger changes in the electrical and electronic components as well as in the software operating the module. Therefore, most of the existing radiochemistry modules can only perform a limited number of predefined operations; i.e., they are not flexible.

Comparing to the traditional wet chemistry, automated modules provide very little flexibility for chemists. Attempts to improve functionality have inevitably lead to complicated schemes, as all functionality should be in place, whether it is needed or not for each particular synthesis. Generally, only operations conceived at the design of the instrument can be performed, to perform new operations new instrument has to be designed.

### SUMMARY

The present invention relates to apparatuses and methods for transferring materials including liquids and gases. Such liquids, gases and solids may be reagents for chemical reactions. Such transfer may be used in systems and methods for carrying out chemical reactions and synthesis. The system may be microfluidic or macrofluidic or a combination of both. The methods synthesize radiolabeled molecules for use in PET or SPECT. (An example of a method of synthesizing radiolabeled molecules, which may be performed by the present invention, is described in U.S. Ser. No. 12/578,175, which is incorporated by reference herein.) The present embodiments may also be used for combinatorial chemistry and drug synthesis.

In one embodiment, the invention is an apparatus for transferring materials as part of a chemical synthesis, the apparatus comprising at least one system block; and at least one transporting mechanism in communication with the system block, the transporting mechanism carrying at least one reagent, wherein the system block comprises some means of extracting the content out of the vial, such as a syringe pump, or a pressure inlet/liquid outlet pair of needles.

The reagents may be contained within containers. The means for extracting may be syringes. The syringes may be pneumatically operated. The apparatus may be macrofluidic or microfluidic. The apparatus may comprise a plurality of system blocks, wherein at least one system block is a reaction chamber and/or an HPLC column. The apparatus may be configured for synthesizing ¹⁸FDG. The transporting mechanism may be a rotating drum comprising a plurality of slots and wherein the system blocks are positioned to correspond to the slots. The slots may be positioned at the perimeter of the drum. At least one slot comprises at least one chemical reagent. The drum rotates may rotate either clockwise or counterclockwise.

In another embodiment, the invention is an apparatus for carrying out a chemical synthesis, the apparatus comprising: at least one rotatable drum comprising at least one slot having at least one chemical reagent, and at least one system block configured to be in communication with the at least one chemical reagent, the system block comprising at least one means for extracting reagent from the slot. The apparatus may comprise a plurality of slots and a plurality of system blocks, wherein each system block is in communication with at least one slot. The position of the system block may be fixed and the rotating drum may be rotatable to place the system block in communication with the reagent. The means for extracting reagent from the slot may be a syringe. The system blocks may comprise a reaction chamber and an HPLC column The system blocks may be positioned to be adjacent a plurality of slots of reagent. The system blocks may be positioned above, below or next two the reagent/cartridge source. The reaction blocks may be stationary or they may be moveable. The drum may rotate clockwise or counterclockwise and may move up and down and/or side-to-side and possibly, at an angle relative to a ground plane or the system blocks.

### BRIEF DESCRIPTION OF THE FIGURES

FIG. 1 is a top plan view of an embodiment of the present invention.

FIG. 2 is a side cutaway view of a portion of the system block with pneumatic needles, a drum and a vial.

FIG. 3 is a side view of different vials that may be used in the system.

FIG. 4 is a top plan view of another embodiment of the present invention.

FIG. 5 is a top plan view of another embodiment of the present invention.

FIG. 6 is an example of a computer system and method used with the present chemistry system.

### DETAILED DESCRIPTION

The present invention relates to apparatuses, systems and methods for transferring materials including liquids, gases and solids. Such liquids, gases and solids may be reagents for chemical reactions. Such transfer may be used in systems and methods for carrying out chemical reactions and synthesis. The system may be microfluidic or macrofluidic or a combination of both. The methods may be for synthesizing radiolabeled molecules for use in PET or SPECT. It also may be used for combinatorial chemistry and drug synthesis.

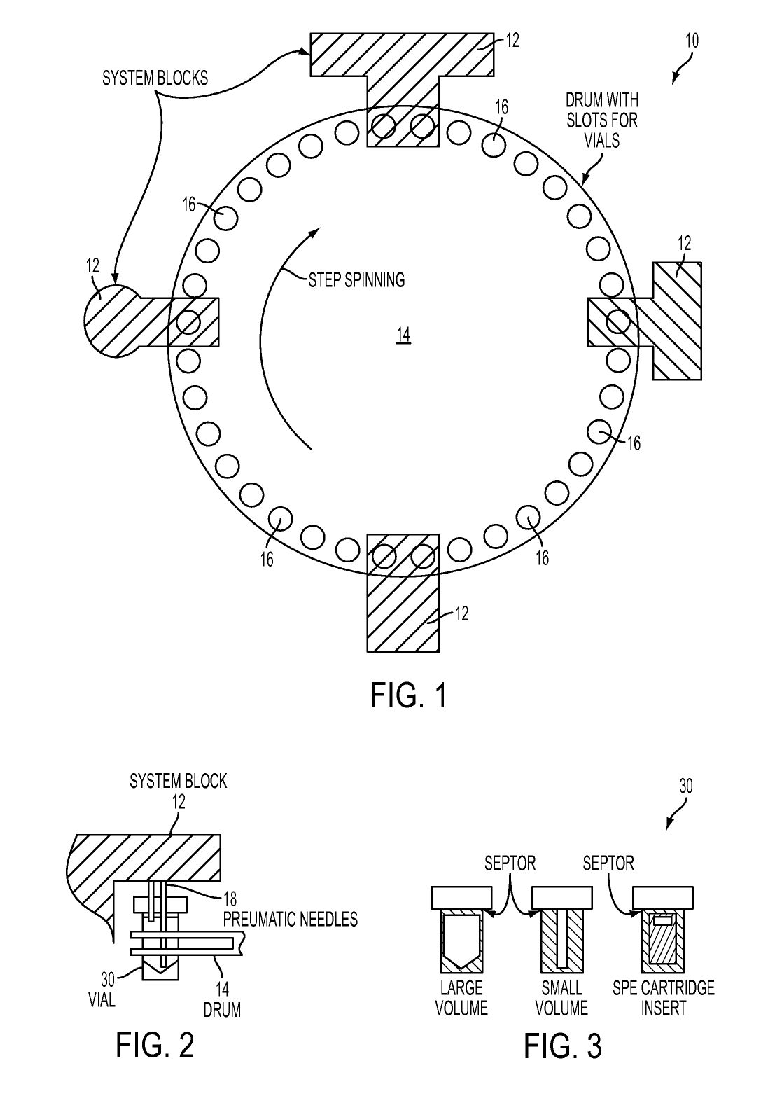

In essence, the present invention proposes moving an entire container of liquid or gas for transfer rather than moving the contents via tubing or other conduit. The containers may be moved via different means. Some examples include a mechanical arm, a rotating or otherwise moving drum with slots, a conveyor belt, etc., (see e.g., FIGS. 1, 4 and 5) In an alternative embodiment, the container of reagent remains in one place while the destination (i.e., a reaction block) moves to the container.

To transfer materials, the container of the materials may be moved to the destination. At the destination, the materials are extracted from the container and processed, acted upon, etc. at the destination by a system block. One mode of extraction may be a syringe that withdraws liquid and then transfers the liquid to its destination. Another mode of extraction may be moving the liquid to a solid phase where solutes are adsorbed; they may then be re-extracted. The liquid may be moved via many different means (syringe, gravity, pressure differential, etc.)

The system or instrument comprises a set of preferably totally independent system blocks not necessarily connected to each other in any way. This way, there is the option to “mix and match” for a desired process. These components communicate via a set of containers, such as vials, which are moveable. Once the container arrives at its destination (or the destination arrives at the container), the contents are extracted and moved to the destination. The movement may occur via a moveable rack such as a rotating drum having a plurality of slots for housing containers of liquids.

In one embodiment, the system or apparatus may include the following components:

A system block. The system block may be built around at least one “functional” part. Such a functional part may be a macro reactor, a microreactor, an HPLC, a temporary storage vial, an evaporation unit, etc. The functional part may have an inlet and an outlet. Both may be designed as a pair of pneumatically operated syringes and needles or a line with valves. A longer needle may be used for dispensing/aspirating solution from/into a vial and a shorter needle may be used for venting/pressurizing a container or vial. It will be understood that other means of extraction may be used such as evaporation of the vial component by heating, condensation of a gas in the vial by cooling of the vial, gravitational or electrostatic transfer of solids, gravitational transfer of liquids etc. Some blocks may also be connected to a waste collection apparatus, such as a bottle, for disposing of waste, such as radioactive waste, generated during cleaning and/or operation.

A container. The container may be a vial. The vial may have septa on the top. The septa may be configured to be punctured by an inlet/outlet of the system block. The vials may have a volume of about 5 ml. But they may have a larger or smaller volume depending on the operation. If there is a need to hold a smaller volume in the vial, an insert of the appropriate volume can be used. If there is a need to hold larger volume, several vials in a row can be used as an alternative to a larger vial The container may be sealed, sealable, open, etc. Thermo isolated containers can be used to maintain low (or high) temperature inside the container.

A solid-phase extraction cartridge(s). An insert containing adsorbent can be fitted into the container to transfer compounds adsorbed on the sorbent. The sorbent may be an ion-exchange cartridge resin for sorption of fluoride anion, C-18 modified silica for extraction of the non-polar solutes, polar resins for extraction of the polar solutes etc. Other phase separation apparatuses may be used in the present invention.

In one embodiment, the system comprises a moveable rack. The movable rack can be built in many ways. For example, a moveable rack may comprise a drum with holes in a portion of the drum, for example, along the edge; a tray with a grid of holes, a chain holding a vial in each segment; or a set of smaller racks transported on a conveyor belt. The movable rack may be configured in a way providing for short and/or long-distance transfer of the containers. The long-distance transfer may be used to deliver containers behind shields attenuating ionizing radiation.

A “microfluidic device” or “microfluidic chip” is a unit or device that permits the manipulation and transfer of small amounts of liquid (e.g., microliters or nanoliters) into a substrate comprising micro-channels and micro-compartments. The microfluidic device may be configured to allow the manipulation of liquids, including reagents and solvents, to be transferred or conveyed within the micro-channels and reaction chamber using mechanical or non-mechanical pumps. Microfluidic devices permit manipulation of extremely small volumes of liquid, for example on the order of about 1 mL to about 1 μL. In a microfluidic system, the containers (such as the vials) may contain a volume of about 5 μL to about 1,000 μL.

The present invention may use reactors based on different principles: batch reactors, semi-batch reactors or flow-through systems. Such reactors are shown, for example, in USSN 11/540,344, U.S. Ser. No. 12/011,220 and U.S. Ser. No. 12/102,822; all of which are incorporated by reference.

An embodiment of the present invention may be constructed using micro-electromechanical fabrication. Alternatively, it may be machined using computer numerical control (CNC) techniques. Examples of materials for forming the device include glass, quartz, silicon, ceramics or polymer. Such polymers may include PMMA (polymethylmethacrylate), PC (polycarbonate), PDMS (polydimethylsiloxane), DCPD (polydicyclopentadiene), PEEK and the like. Such devices may comprise columns, pumps, mixers, valves and the like.

The description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

The detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

The present system provides many advantages:

Flexibility without complexity: any component of the system can communicate with any other component of the system without being physically connected to it. The links between components are not realized in the form of tubing, therefore complex and unreliable parts like 24-port distribution valves can be avoided.

As an example, an HPLC functional block can accept reaction mixture from a reactor functional block and then feed the purified product back to the reactor, or transfer it to the reformulation functional block or directly to the final product vial. If the system was build with traditional lines, having this option would require a separate line for each of the mentioned transfers. It would also require a set of valves. In case of the proposed interface, HPLC functional block may deliver purified product into a movable container, which can be moved to the inlet of any of the accepting functional blocks. Having this flexibility does not require any hardware changes.

Easy upgrades, simplified development process: system blocks and other components can be added, removed or changed for newer or different versions without changing the general outline of the design. Blocks developed in the future can be easily added to already-installed instruments. Design of functional components can be performed by independent groups of developers, as long as the components conform to the interface standard. The core software of the instrument may only operate the movable rack and use the software operating the functional blocks as plug-ins, add-ons, methods of the classes provided in third-party libraries, etc.

Simple plumbing: there is virtually no plumbing, therefore no clogging, no pinched lines and no leaks.

One instrument stands for several instruments: several independent chemical processes can be performed on one instrument featuring several reactors. These processes can even share some functional parts, like an HPLC system. Need to perform several parallel processes can be satisfied with one instrument, without installation of several units. There is no need to put multiple instruments in one hot cell; instead additional reactors can be mounted onto already installed instrument.

Cold box—hot box separation enabled without long tubes: vials can be sent from cold box to inside shielding via a pneumatic tube or conveyor belt. For a description of the hot box—cold box technology, see U.S. Ser. No. 12/803,862 and U.S. Ser. No. 12/986,323 which are incorporated by reference, in its entirety.

Kits for synthesis: disposable racks (or sets of containers or vials) with vials already filled and mounted can be manufactured and sold as consumables.

Serviceability. Functional blocks are not integral parts of the system, a malfunctioning system block can be taken off, tested and repaired or sent to a factory for repair without disrupting the entire system.

Cleaning cycle integrated into the run: a set of vials with cleaning solvents for each system block can be added on the rack along with a set of empty vials for collection of waste. Parts of the cleaning cycle can be executed already during the run and some blocks can be used more then once during the run.

Less clutter in the box. Only functional components needed for the particular process stay in the instrument. For example, the fact that the instrument can potentially use solid-phase extraction cartridges does not mean that all of them are present inside the unit. The instrument has only cartridges it needs for the synthesis.

FIG. 1 shows a top plan view of one embodiment of an apparatus 10 of the present invention. The apparatus comprises a plurality of system blocks 12. The system blocks may be the “functional” part of the system. For example, the system blocks may be a reactor, HPLC, temporary storage container, etc. The system blocks may be the same component or they may be different components. The system blocks may be microfluidic or macrofluidic components or a combination of both. As shown in FIG. 1, the system blocks 10 are positioned above a transporting mechanism 14, which in this embodiment, is a rotating drum. It will be understood that the system blocks 10 may be positioned elsewhere relative to the transporting mechanism (i.e., below, to the side, etc.).

The transporting mechanism (drum, conveyor belt, robotic arm see e.g., FIGS. 1, 5 and 6) preferably comprises portions, such as slots or holes 16 for housing at least one container (30, FIGS. 2 and 3). The slots 16 may be filled with at least one container 30 comprising a gas, liquid, solid or other reactant. In alternative embodiments, the slots house the reactant directly without a removable container. In yet another embodiment, at least one container is empty and the system block contains reagent.

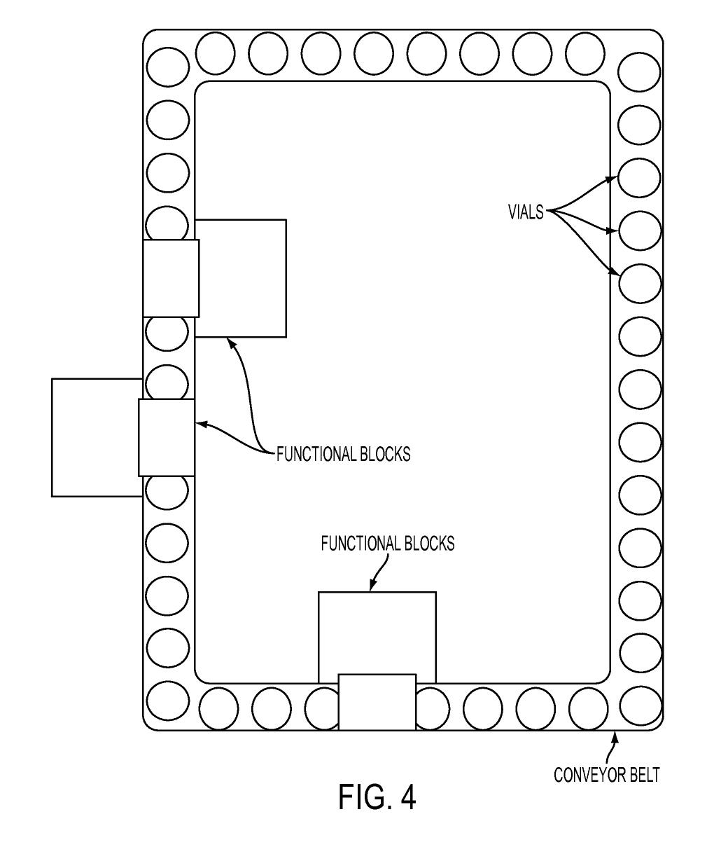

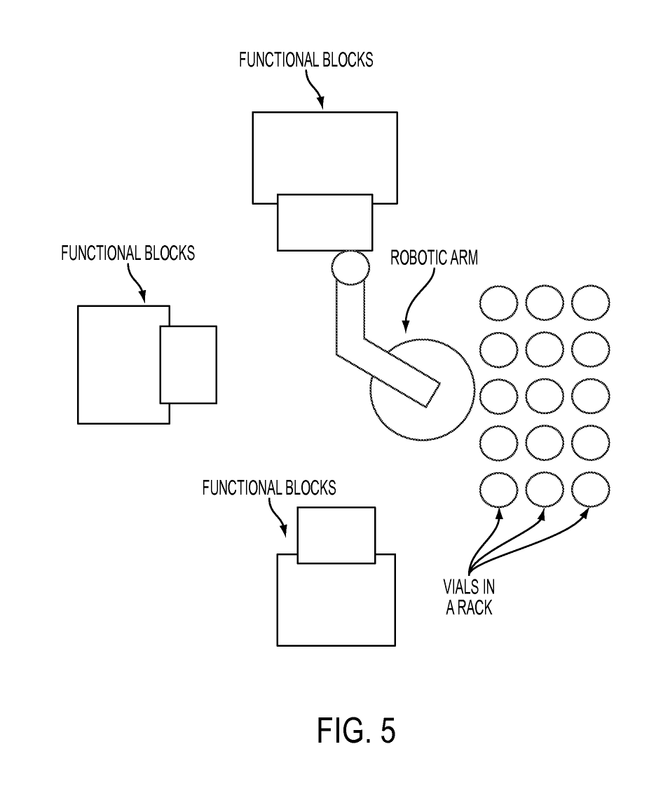

The transporting mechanism moves the containers toward the desired system block. In the embodiment shown in FIG. 1, the drum rotates to move the vials into position. It will be understood that various transporting mechanisms may be used. In the embodiment shown in FIG. 4, a conveyor belt moves the containers or vials to desired position(s); namely functional block(s). In the embodiment shown in FIG. 5, a robotic arm moves vials in a supporting apparatus such as a rack. Again, the robotic arm moves the vials to functional blocks. As described below, the functional blocks may be reactors, separation apparatuses such as chromatography columns, ion exchange columns, product purification column, vents, syringes, reagent sources, product sources, intermediate product sources, holding chambers, pumps, detection apparatuses, etc.

Once the desired vial is in position, its contents may be extracted. In embodiments where the vials are empty, they may be filled by the system block.

As shown in FIG. 2, the contents may be extracted by at least one syringe 18. The syringe may be pneumatically operated. It also may be operated via other means such as mechanically, electrically, chemically (via energy from reactions), etc. It will be understood that other means may be used for extracting the contents from the vial. For example, the contents may simply be poured out or the bottom may release allowing the contents to fall via gravity, the content may be evaporated with active heating or by ambient heat; the content may be attracted by the electric or magnetic force.

Once the contents are extracted, they are stored for an amount of time. This may be a matter of seconds (or less) or a matter of hours or days. Usually, the reagents are extracted and then substantially immediately transferred to another system block. For example, the reagents may be transferred to an HPLC column or in the active area of the reactor. After under going chromatographic separation or chemical reaction, the modified reagents may then be transferred to another block, which may be a reactor, a reformulation system, an evaporation system, etc. As shown in FIG. 1, the containers with reagents are transferred by the rotating drum.

As shown in FIG. 3, the containers may be vials 30. The vials may be configured to house various volumes of liquid, solid or gaseous reagents. The reagent may also be in the form of condensed gas. The vials may be configured to store and dispense a large volume of reagent (more than 1 mL), a small volume (e.g., on the order of microliters) or an SPE cartridge. It will be understood that virtually any reagents may be used with the present system including disposable cartridges.

The disposable cartridges may be pre-packaged, sealed and fully enclosed with self-contained materials. The inlet and outlet ports of the cartridge may be self-sealing via various ports, valves and/or gaskets. The cartridges of the invention may be disposable after a single use or after a few uses. The cartridges are configured for the storage and the delivery of materials, to a functional block of the system or out of it. The cartridge may comprise housing or casing enclosing the materials. The materials therein may be in an amount for just a single run or synthesis. The disposable cartridge may be a Solid Phase Extraction cartridge as described in U.S. Ser. No. 12/803,862.

The cartridge is readily available for delivery of the correct amount of reagent to the synthesizer reaction cell. That is, the end-user of the instrument can be supplied with a pre-measured amount of the reagent packed in the cartridge. This way the likelihood of the measuring error is greatly diminished or eliminated. The cartridges of the invention can be safely stored, under appropriate conditions, at appropriate temperatures, for a substantial time period without significant reagent loss. A plurality of such cartridges, each providing a different reagent and/or different amount of the reagent for use depending upon the desired scale for the synthesis, can be maintained in inventory for use as needed. The cartridge casing can be fabricated from any material, preferably, inert to materials used in automated synthesis of the desired product. Cartridges of the invention are useful in conjunction with known forms of software for automated synthesizers of radiolabeled compounds. The cartridge may comprise novel means for attaching to and interfacing with the drum. It also may comprise novel means for interfacing with a synthesis device or another reagent device.

The cartridges may be used in a synthesis independent from each other or form combinations needed to carry out a particular protocol. The cartridge may contain only one type of material, or comprise a set of individual containers to store a set of materials.

The cartridge may be manufactured in a form of a single part, or comprise a series of parts attached to each other via flexible or movable links. The system may comprise chains of different or identical cartridges. The drum may comprise containers inserted in predefined positions. For example, the drum may have a slot with a certain shape that corresponds only to a certain container. Or, the containers (cartridges, for example) may be universal.

The cartridges may comprise virtually any material. The materials contained in the cartridges may be in the form of gas, liquid, solid, suspension, emulsion, true or colloid solution. This material may be in the form of pure chemical compound, mixture of compounds or solution of a compound or mixture of compounds. It can also be in a form of a compound reversibly absorbed on an inert carrier, or reversibly chemically bound to a carrier.

The material contained in the cartridge can play any role in the synthesis, examples include: reagent, reactant, catalyst, phase-transfer reagent, emulsifier, pH modifier, an intermediate product, byproduct, waste, solvent or absorbent. Some examples may include: K₂CO₃, K222, MeCN, Mannose Triflate, acids, bases, water or any other gases or liquids.

It will also be understood that the system may be run by an operator via a computer and in some embodiments, may be automated. The system may comprise a computer and a computer-readable media for storing a program configured to operate the system.

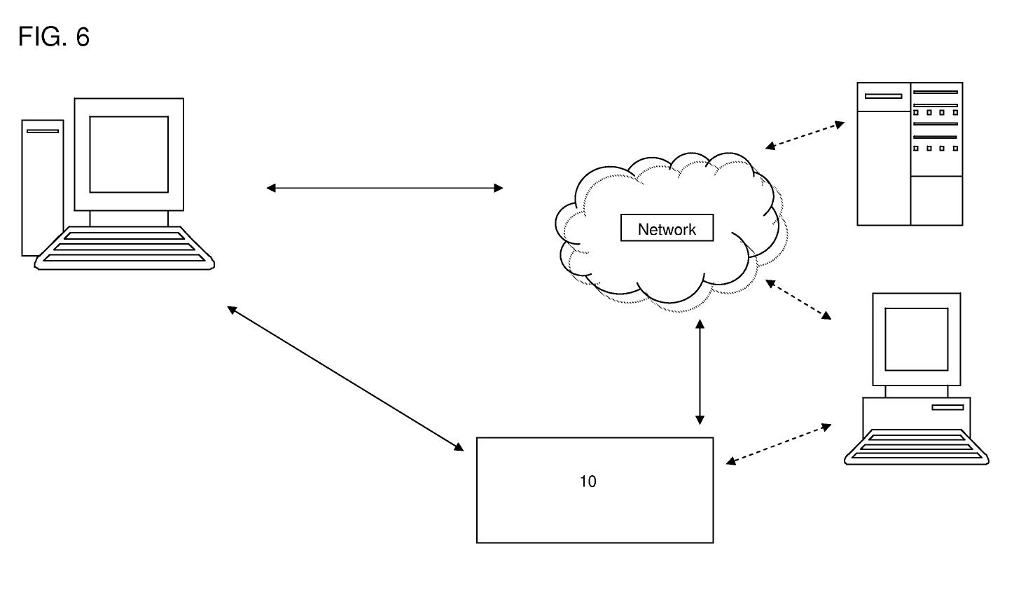

As shown in FIG. 6, the system 10 may be coupled to a user computer 120 and the computer 120 and/or system 10 may be coupled to a network 122, which may be coupled to a server 124 via a gateway. The system 10 and/or network may be in communication with other user computers 126.

The computers 120, 126 may include a processing device, a system memory, a system bus coupling the system memory to the processing device, a storage device, such as a hard disk drive, a magnetic disk drive, e.g., to read from or write to a removable magnetic disk, and an optical disk drive, e.g., for reading a CD-ROM disk or to read from or write to other optical media. The storage device may be connected to the system bus by a storage device interface, such as a hard disk drive interface, a magnetic disk drive interface and an optical drive interface. Although this description of computer- readable media refers to a hard disk, a removable magnetic disk and a CD-ROM disk, it should be appreciated that other types of media that are readable by a computer system and that are suitable to the desired end purpose may be used, such as magnetic cassettes, flash memory cards, digital video disks, etc.

As shown in FIG. 6, the computer is in communication with the system 10. “In communication” means that the computer is physically (e.g., wired) or wirelessly connected to the chemical system and may connected to the reactor directly or via other media. Various sensors (e.g., flow sensors, liquid-gas interface sensors, radioactivity sensors, pressure sensors, temperature sensors, and the like) and other apparatus components (e.g., valves, switches, etc.) can be integrated into the chemical system and be in communication with the computer for process control and monitoring purposes.

The computer, or other external input device, may be coupled to a program storage device and to a controller. The controller may be coupled to any component on the system including the transporting mechanism, vials or containers, or system block.

In accordance with an embodiment of the present invention, the computer program and interface may be in communication with a PC and a Programmable Logic Controller (PLC), such as a Ladder Logic PLC. The hardware of the synthesis system may be controlled by the PLC. The PLC may control all of the I/O in the reactor using, for example, 6 analog outputs, 8 analog inputs, 24 relay outputs, 18 digital inputs, 17 digital outputs, and a Ladder Logic program.

The computer program may be a software control program written in Visual Basic but may be written in other programming language. The standard PC, using, for example, a Visual Basic control software, may control the PLC and 8 precision syringe pumps using serial communication. This provides a very detailed graphical interface allowing visualization of what is happening in the hardware, and controlling the various valves, pumps, heaters and other components.

The present system may be used with the GUI interface shown in U.S. Ser. No. 13/027,465, which is incorporated by reference.

In one embodiment, the system preferably is configured to synthesize chemicals used in diagnosis, such as PET. These chemicals comprise at least one radionuclide, which may be selected from the group consisting of ¹¹C, ¹³N, ¹⁵O, ¹⁸F, ⁶¹Cu, ⁶²Cu, ⁶⁴Cu, ⁶⁷Cu, ⁶⁸Ga, ¹²⁴I, ¹²⁵I, ¹³¹I, ⁹⁹Tc, ⁷⁵Br, ¹⁵³Gd and ³²P.

As an example, the present system may be used to synthesize FDG. First, target water is passed through an ion exchange cartridge to trap F-18 out of a dilute solution. This solution may be placed in a vial of the system. K₂CO₃ may then be released into a concentrated solution, which is placed into another vial. The K₂CO₃ vial may be moved toward a system block that is a reactor. Next, a K222/MeCN solution may be placed within a vial and delivered to the reaction block. After the reagents have mixed, nitrogen may be delivered, again, via a vial. Solvents evaporate quickly leaving behind a residue containing an F-18 KF/K222 complex. Next, the precursor (mannose triflate) may be delivered to the reactor.

The resulting reaction mixture may be heated, allowing it to boil for a few seconds to achieve mixing. The residue is usually then re-dissolved. Next, the reaction mixture may be superheated to about 140° C. After cooling, the solvent is evaporated by the flow of nitrogen. Deprotection is then carried out by bringing ethanolic HCl into the reactor. Once again, the reaction mixture may be heated. Then, the solvents may be evaporated, leaving behind a residue of FDG. The final step of product elution takes place when water enters the reactor from one channel and carries the products out of another channel.

Having thus described in detail various embodiments of the present invention, it is to be understood that the invention defined by the above paragraphs is not to be limited to particular details set forth in the above description as many apparent variations thereof are possible without departing from the spirit or scope of the present invention.

We claim:

1. An apparatus for transferring materials as part of a chemical synthesis, the apparatus comprising:
at least one system block; and
at least one transporting mechanism in communication with the system block, the transporting mechanism carrying at least one reagent,
wherein the system block comprises at least one means for extracting reagent from the transporting mechanism.

2. The apparatus of claim 1, wherein the reagents are contained within containers.

3. The apparatus of claim 1, wherein the means for extracting are syringes.

4. The apparatus of claim 3, wherein the syringes are pneumatically operated.

5. The apparatus of claim 1, wherein the apparatus is microfluidic.

6. The apparatus of claim 1 comprising a plurality of system blocks, wherein at least one system block is a reaction chamber.

7. The apparatus of claim 6, wherein at least one system block is an HPLC column or reaction chamber.

8. The apparatus of claim 1, configured for synthesizing ¹⁸FDG.

9. The apparatus of claim 1, wherein the transporting mechanism is a rotating drum comprising a plurality of slots and wherein the system blocks are positioned to correspond to the slots.

10. The apparatus of claim 9, wherein the slots are positioned at the perimeter of the drum.

11. The apparatus of claim 10, wherein at least one slot comprises at least one chemical reagent.

12. The apparatus of claim 11, wherein the drum rotates either clockwise or counterclockwise.

13. An apparatus for carrying out a chemical synthesis, the apparatus comprising:
at least one rotatable drum comprising at least one slot having at least one chemical reagent,
at least one system block configured to be in communication with the at least one chemical reagent, the system block comprising at least one means for extracting reagent from the slot.

14. The apparatus of claim 13, comprising a plurality of slots and a plurality of system blocks, wherein each system block is in communication with at least one slot.

15. The apparatus of claim 13, wherein the position of the system block is fixed and the rotating drum is rotatable to place the system block in communication with the reagent.

16. The apparatus of claim 13, wherein the means for extracting reagent from the slot is a syringe.

17. The apparatus of claim 14, wherein the system blocks comprise a reaction chamber and an HPLC column.

18. The apparatus of claim 15, wherein the system blocks are positioned to be adjacent a plurality of slots of reagent.

19. The apparatus of claim 13, further comprising a computer in communication with the apparatus, the computer comprising at least one program stored on a tangible computer-readable media, wherein the apparatus is operable by the computer.
